(19) United States
(12) Patent Application Publication
(10) Pub. No.: US 2021/0088369 A1
(43) Pub. Date: Mar. 25, 2021

(54) BLOCKAGE DETECTION USING MACHINE LEARNING

(71) Applicant: ADS LLC, Huntsville, AL (US)

(72) Inventor: Daniel Redmond, Columbia, MO (US)

(73) Assignee: ADS LLC, Huntsville, AL (US)

(21) Appl. No.: 17/031,091

(22) Filed: Sep. 24, 2020

Related U.S. Application Data
(60) Provisional application No. 62/904,720, filed on Sep. 24, 2019.

(51) Int. Cl. G01F 15/06; E03F 3/00; G06N 20/00; G01F 1/86

(52) U.S. Cl. CPC G01F 15/061; G01F 1/86; G06N 20/00; E03F 3/00

(57) ABSTRACT

One or more techniques and/or systems are disclosed for detecting the presence or formation of a blockage in a sewer system using a machine learning (ML) model. The ML model may be trained using a supervised learning method; and may be used to analyze various inputs from a sewer system to automatically sense developing sewer blockages. The systems and techniques described herein may also indicate the type of blockage that is forming, such as silt accumulation; sediment buildup; ragging; root intrusion; fats, oils, and grease (FOG), etc.) prior to a full blockage to allow preventative cleaning operations.

### CROSS-REFERENCE TO RELATED APPLICATIONS

This application claims priority to U.S. Ser. No. 62/904,720, entitled BLOCKAGE DETECTION USING MACHINE LEARNING, filed Sep. 24, 2019, which is incorporated herein by reference.

### BACKGROUND

Sewer systems transport wastewater from businesses, private residences, and other locations to wastewater treatment plants (WWTPs). The sewer systems utilize pipes, conduits, open channels, or other similar means to transport wastewater under a variety of flow conditions. Blockages disrupt the normal or expected operation of sewer systems and can cause overflows when undetected or unresolved in sanitary, storm, combined sewer systems and other fluid flow discharge systems. Overflows of untreated wastewater from sewer systems, storm water, runoff, etc., can pose an important concern for public health and the environment.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The present application discloses one or more systems and techniques for mitigating overflows in drainage systems, such as sewers, by detecting sewer system blockages early, such as when they are forming. Early detection may allow sewer cleaning operations to remedy the blockage before it results in an overflow. The one or more systems and techniques may use machine learning (ML) to analyze various inputs from a sewer system to automatically sense developing sewer blockages. The one or more systems and techniques may also indicate the type of blockage that is forming (e.g., silt accumulation; sediment buildup; ragging; root intrusion; fats, oils, and grease (FOG), etc.).

In one example of a system for detecting an obstruction of flow in a sewer system, one or more input devices can each comprise a sensor that generates real-time data indicative of a detected a fluid flow characteristic in a target sewer system. In this implementation, a blockage prediction platform can comprise a machine learning model, where the blockage prediction platform operably receives the real-time data from the one or more input devices and determines a blockage prediction for the target sewer system based on the real-time data. Further, a user device can be communicatively coupled with the blockage prediction platform; and the user device can display the results of the blockage prediction for the target sewer system from the blockage prediction platform. In this implementation, the machine learning model can be trained using data indicative of a variety of blockage events.

In one example, a method for training a ML model using supervised learning to detect a sewer blockage can comprise collecting data representative of a sewer blockage, processing the data, applying at least one engineering feature to the data, applying at least one ML model to the data, evaluating at least one ML model, and/or developing at least one suitable ML model to arrive at a suitable ML model for the target situation.

In another example, a method for determining the existence of a sewer blockage can comprise collecting data representative of sewer flow conditions, processing the data, applying engineered features to the data, applying a ML model to the data, and using the ML model to determine the existence of a sewer blockage.

In another example, a method for using a trained ML model to detect a sewer blockage can comprise applying at least one of an engineering formula to data relating to the flow of liquid, applying at least one of a suitable ML model to data relating to the flow of liquid, and determining the existence of a sewer blockage.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is a diagram showing the system 100, as described herein.

FIG. 2 is another diagram showing an exemplary embodiment of the system shown in FIG. 1.

FIG. 3 is another diagram showing an exemplary embodiment of the system shown in FIG. 1.

FIG. 4 is an exemplary graph showing data for an obstruction of flow.

FIG. 5 is an exemplary graph showing data for an obstruction of flow.

FIG. 6 is an exemplary graph showing data for an obstruction of flow.

FIG. 7 is an exemplary method for detecting a sewer blockage using ML technology.

FIG. 8 is an exemplary representation of a ML model in a training environment and a ML model in a production environment.

FIG. 9 is an exemplary level monitor that may be used in the system 100.

FIG. 10 is an exemplary flow monitor that may be used in the system 100.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form to facilitate describing the claimed subject matter.

Overflows are discharges of fluids from unintended or unpermitted locations in a sewer system, which can include sanitary sewers, storm sewers, combined sewer systems (e.g., combined sanitary and storm), or other fluid discharge systems. Overflows can contribute to unwanted situations such as beach closures, basement flooding, traffic hazards and other concerns. While most sewer utilities have established Sewer Overflow Response Plans to react to overflows when and where they occur, mitigating their appearance in the first place can be a better approach. The use of the terms “sewer blockage” or “sewer obstruction” in this application may be used interchangeably and are intended to have the same meaning (e.g., that a flow of sewage may be at least partially prevented from passing through a sewer system of pipes, conduits, open channels, or the like).

Statistics reported by the United States Environmental Protection Agency (EPA) and corresponding state regulatory agencies note that sewer blockages are a main cause of overflows, contributing to roughly 50% of all overflows in sanitary sewer systems. For example, one of the most common causes of blockages in gravity sewers are non-compostable wipes; debris; fats, oils, and grease (FOG); sediment build-up; and root intrusion.

To reduce the number of overflows caused by blockages in gravity sewers, sewer utilities have generally adopted preventive approaches in the form of preventive sewer cleaning. The approach is simple: clean every gravity sewer on a pre-determined schedule, often on the order of once every three to ten years. While this approach is straight-forward and makes a positive impact, gravity sewers are often cleaned that may not need to be cleaned, and gravity sewers that need to be cleaned may not be cleaned when needed. As a result, some blockages continue to go undetected and result in overflows. Therefore, sewer utilities will often adapt the approach and implement higher frequency preventive cleaning for specific gravity sewers where the probability or consequence of overflows is greater. While incremental improvements are observed, the same weakness is still noted. Gravity sewers are often cleaned that do not need to be cleaned, and gravity sewers that need to be cleaned may not be cleaned when needed.

To improve the implementation efficiency of sewer cleaning operations and equipment, level monitoring technologies have been developed to help detect blockages in their earlier stages of formation and allow sewer utilities to respond in a proactive mode rather than a rescue or recovery mode. This allows sewer utilities to apply the right resources in the right place at the right time. However, while level monitors provide the vision to know flow conditions at certain locations within a sewer system, use of monitors alone still requires an operator with time and expertise to review the data to determine if a blockage is developing. The present application describes methods to mitigate overflows by combining data such as flow depth data from a level monitor with machine learning (ML) technology to autonomously sense developing sewer blockages in their earliest stages of formation.

Because blockages typically develop slowly, they may be detected early enough for proactive responses. For example, depending on the type of blockage, they can be identified in advance (e.g., several days and sometimes two weeks, or more) before operational problem may result. By having advance notice of a blockage forming, for example, a sewer utility may be able to dispatch cleaning operations, as needed, to mitigate an overflow before it occurs. As a result, the concerns that result from an overflow can be mitigated while having much greater visibility into conditions within the sewer system.

In one aspect, in addition to predicting when a blockage may be occurring, the methods and systems described herein can also indicate a type of blockage that is forming. For example, a blockage formed by fats, oils, and grease (FOG) typically has a different data signature than a blockage formed by silt and sediment build-up. Further, for example, data identified that is indicative of a root intrusion may have a different signature from FOG and silt and sediment build-up. In this aspect, the data signature that is indicative of the type of blockage may be useful to help cleaning operations planners identify appropriate tools for removing the blockage from the sewer, particularly where some blockages may be more critical than others. For example, a cleaning operation may prepare with appropriate tools, such as a root saw instead of a cleaning nozzle where needed, so that the proper equipment can be prepared and made available for use in advance.

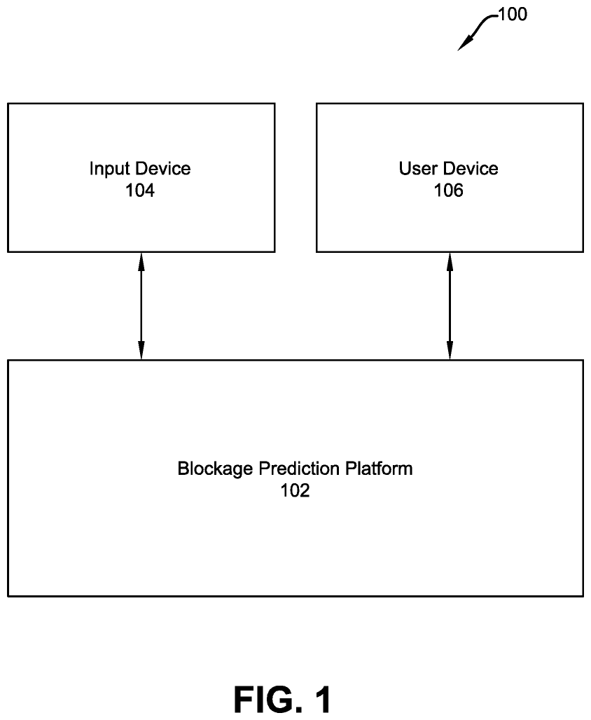

FIG. 1 shows one implementation of an exemplary system 100 that may be used to detect sewer blockages using ML technology. In this implementation, the exemplary system 100 may include a prediction platform 102, one or more input devices 104, and one or more user devices 106. In some implementations, the one or more input devices 104 can be disposed in a target sewer system, to detect and/or identify a condition in the target sewer system, such as fluid flow rate, fluid depth, fluid condition, etc. The prediction platform 102 can receive data from an input device 104 that is indicative of fluid conditions within a sewer. The prediction platform 102 may analyze the data to predict blockages that may be forming in any type of sewer system such as a pipe, conduit, or open channel at or near the location of the input device 104, based on the data from one or more of the input devices 104. The results from the prediction platform 102 (e.g., predictions or determinations of formed or forming blockages, etc.) may be provided to the user device 106. The user device 106 may provide indications (e.g., visual, auditory, etc.) for a user to receive, allowing the user to plan operations based on the results of the prediction platform 102.

The input device 104 may be any sensor, measurement device or similar component. For example, the input device 104 may be a level monitor (e.g., ADS® ECHO™, etc.) to provide the level of wastewater in a manhole or sewer pipe. As an example, the level monitor may indicate the current depth of the wastewater in the sewer. In another example, the input device 104 may be a flow monitor (e.g., ADS TRITON+®, etc.) to provide a flow depth, flow velocity, and/or flow rate of wastewater in a manhole or sewer pipe. Further, for example, the input device 104 may be any other sensor, monitor or device such as, but not limited to, a wastewater temperature indicator, ambient air temperature indicator, a rainfall indicator, a pressure indicator, a blockage indicator, a pump status indicator, a valve status indicator, or other similar devices, that provides data indicative of a condition in the sewer system.

In some implementations, the user device 106 may display results relating to a sewer blockage indication (e.g., existing blockage, developing blockage) that are generated by the prediction platform 102. For example, the user device 106 may comprise a computer display screen, a tablet, a cell phone, human machine interface (HMI), or any other device capable of displaying results. For example, the results may be in the form of visual displays, graphs, alarms, notifications, statuses, etc. In addition to display capabilities, the user device 106 may allow a user to further interact with the prediction platform 102 using various commands or inputs, such as to manipulate results, provide different views, and or additional analysis of the results.

In an exemplary embodiment, the user device 106 may have network communications that provide access to a web application for monitoring the various features of the system 100. For example, the user device 106 may display data from a web application to allow a user to remotely monitor the status of the various input devices 104, current alarms, blockage statuses, maintenance notifications, etc. Further, the web application may allow a user to manage the input device 104 statuses and alarms and to generate various notifications and reports on the data. In another exemplary embodiment, the user device 106 may provide use of a mobile application for monitoring the various features of the system 100. For example, the user device 106 may run an application that is downloaded or accessed from a communications network (e.g., the Internet).

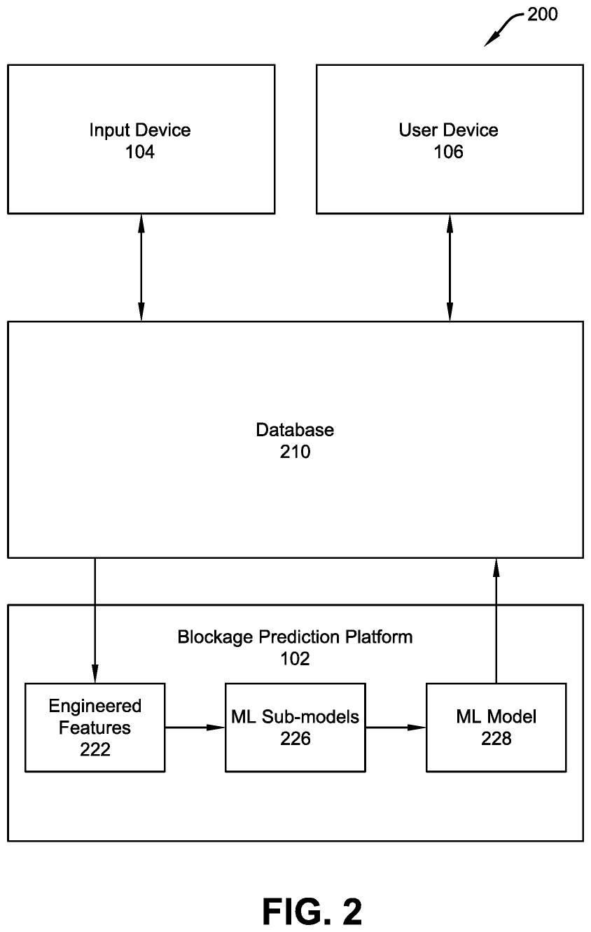

FIG. 2 is an example implementation of a system 200, which illustrates various features of system 100 in greater detail. It should be appreciated that the system 200 may include various additional features and need not have all of the features given in the above example. System 200 is given as an example and is not intended to limit the system to the various features disclosed. In this implementation, system 200 can comprise one or more input devices 104, one or more user devices 106, a database 210, and a blockage prediction platform 102. In this implementation, the blockage prediction platform 102 can comprise engineered features 222, ML sub-model(s) 226, and a ML model 228, as described below. In some implementations, one or more portions of the system 200 may be implemented as software, such as software as a service (SaaS).

As an example, engineered features 222 can comprise flexible binning of data generated by the one or more input devices 104. For example, allowing data to be binned into one or more data sets (e.g., from/in the database 210) based on predictive learning determinations. Further, engineered features 222 can comprise a variety of statistical models for the generated data; as well as utilization of basic and synthetic hydrology features. Additionally, engineered features 222 can comprise multi-resolution time-frequency analysis (e.g., S-transform, short time Fourier transform, etc.), and machine learning (ML) sub-models (e.g., possible system similar to the main model, with its own engineered features and potential sub-models, which may be imbedded within the main model, iteratively), and other time series algorithms such as dynamic time warping (e.g., an algorithm for measuring similarity between two temporal sequences, which may vary in speed).

In some implementations, the database 210 may comprise one or more cloud-based databases, one or more remote databases, one or more local databases, or a combination of these databases, and may manage data from one to many input devices 104. In some implementations, the prediction platform 102 may access data from the database 210 to determine whether a blockage (e.g., beginning, partial, or more) exists in one or more portions of a target sewer system, such as proximate to one or more of the input devices 104. For example, the database 210 may also be implemented as one or more types of database such as a SQL, RDBMS, or relational database. Further, the database 210 may also be implemented as a NoSQL or non-relational database. One skilled in the art will recognize that any suitable database may be used, and in other embodiments no database may be used.

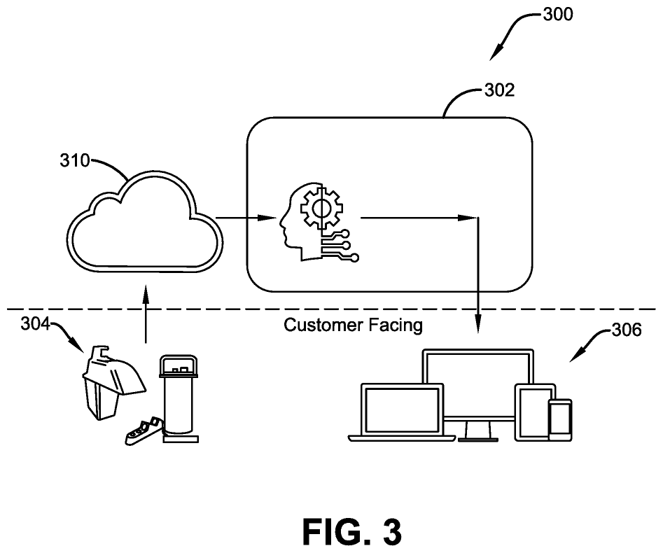

FIG. 3 shows one implementation of one or more portions of one or more systems described herein. In this implementation, an exemplary system 300 may be used to detect blockages and/or potential blockages in sewer systems, for example, when or before they occur. In this example system 300 can comprise one or more input devices 304, such as flow detectors, flow sensors, depth sensors, fluid condition sensors (e.g., temperature, etc.), a database 310 (e.g., cloud-based), a machine learning platform 302, and one or more user devices 306. In this example implementation, the arrows between the devices 302, 304, 306, and 310 may represent an exemplary flow of data. As an example, the one or more sensors 304 may detect conditions in the target sewer system and send data indicative of the conditions to the database 310 (e.g., or the database may pull data from the input device(s) (304). Further, the machine learning platform 302 may pull target data from the database 310 (e.g., or it may be pushed to the machine learning platform (302) as needed to identify blockage or potential blockage conditions). Results of the data processed by the machine learning platform 302 can be sent to the one or more user devices 306 to be viewed and/or manipulated by a user.

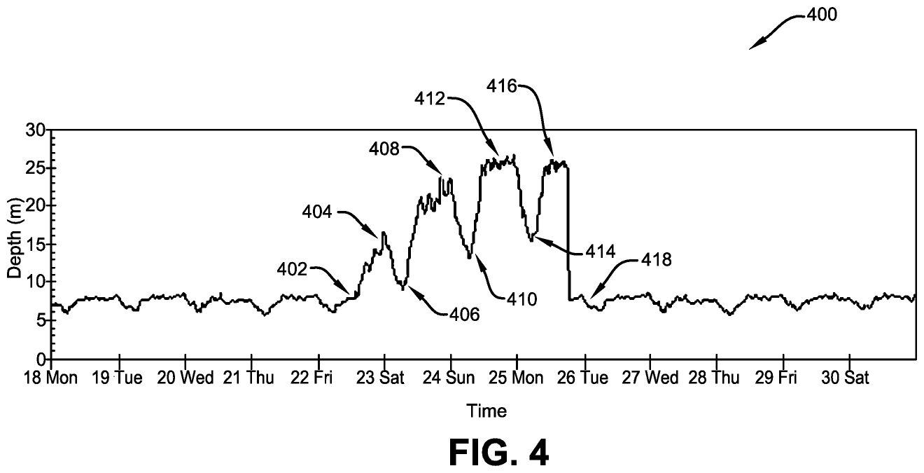

FIG. 4 is a graphical representation of a graph 400 indicative of a sewer blockage event. In this example, the graph 400 indicates a fluid flow depth in a gravity sewer on the y-axis and the date/time on the x-axis. A blockage (e.g., obstruction of flow) or a developing blockage is characterized by the gradual increase in the maximum daily flow depth. As shown in graph 400, the maximum daily flow depth 404, 408, 412, 416 increased from level 404 to level 408 to level 412, and then to level 416. In this example, the increase shown in graph 400 can be indicative of the presence of a developing blockage in a sewer. Further, in this example, the sharp decrease in maximum daily flow level between levels 416 and 418 is indicative of the blockage being cleared (e.g., by a cleaning operation).

In this example graph 400, a minimum daily flow depth 402, 406, 410, 414 shown in graph 400 can be indicative of the type of blockage rather than the presence of a blockage. For example, the type of increase in the minimum daily flow depth indicated by levels 402, 406, 410, and 414 may indicate that the blockage is a result of debris accumulation in the sewer system. In other implementation, alternate patterns in the minimum daily flow depth may be indicative of other types of blockages in the sewer system, such as resulting from FOG or silt.

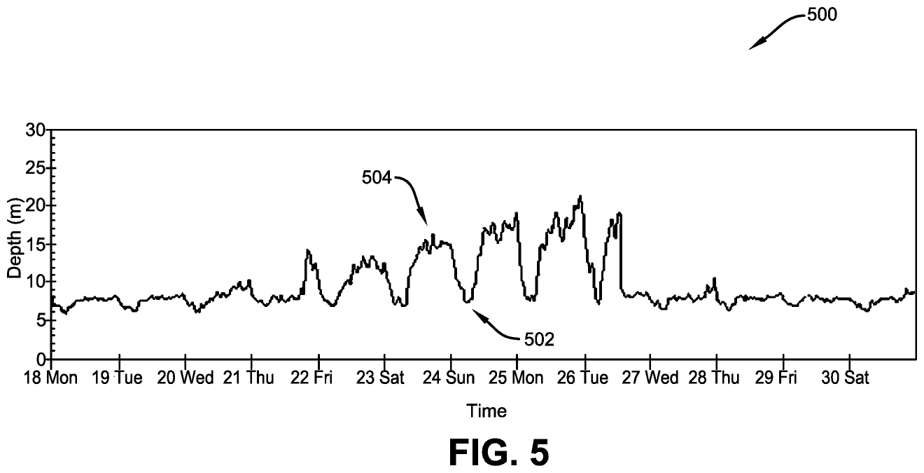

FIG. 5 is a graphical representation of another exemplary graph 500 of an example sewer system blockage event. In this example, the graph 500 indicates another increase in maximum daily flow depth 504, at a different rate than that of graph 400 that may indicate a blockage in a sewer. Further, in graph 500, the change in minimum daily flow depth 502 is different than is indicated in graph 400, which may be indicative of a different type of blockage. For example, the lack of a gradual increase of minimum daily flow depth shown in graph 500 (e.g., compared with graph 400) may be indicative of a blockage resulting from FOG (e.g., grease) accumulation on the pipe wall.

As an illustrative example, one distinction between debris accumulation and FOG accumulation in a sewer is where the blockage begins to form, and not be related to the speed of the build-up over time. For example, debris can settle to the bottom of the pipe, which is why it becomes evident as there are increases in both minimum and maximum flow depths. On the other hand, for example, grease is less dense than water, so it can float on the water surface. In this example, as a result, the grease will often attach or get caught on pipe defects at or near the water line. Further, the grease can then begin to accumulate on the pipe wall at the water line. At night, at least initially, the water level in a typical sewer can drop below the grease accumulation, and the water level may be unaffected by it. However, in this example, the following day when the water level rises, it can rise higher than normal because the grease accumulation is partially blocking the pipe. As an example, this is why results can indicate maximum depths rising while minimum depths stay about the same as an indication for grease blockages.

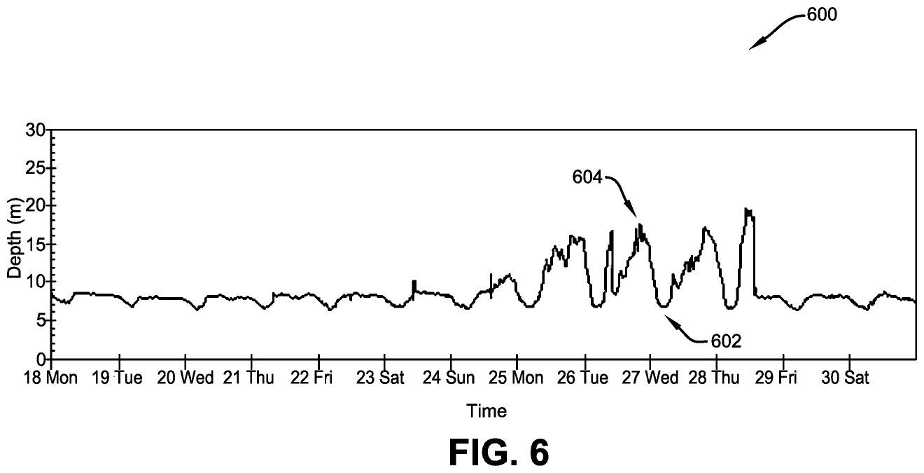

FIG. 6 is a graphical representation of another exemplary graph 600 of another example sewer blockage event. In this example, the graph 600 indicates an increase in maximum daily flow depth 604, much like in graphs 400 and 500, which is indicative of a blockage in the sewer system. Further, in the graph 600, indicates another, different change in minimum daily flow depth, which is also different than was indicated in graph 400, which may be indicative of another type of blockage. For example, the lack of gradual increase of minimum daily flow depth shown in graph 600 may indicate that the blockage is caused by a grease accumulation on the pipe wall near the flow surface. As described above, the data indicative of the increase in maximum daily flow depth can indicate a potential blockage, while the data indicative of the minimum daily flow depth can be indicative of the type of blockage. In this way, for example, the combination of sensor data with visual observation of the type of blockage can be used for supervised training of the ML model to help identify the presence of a blockage and the type of blockage.

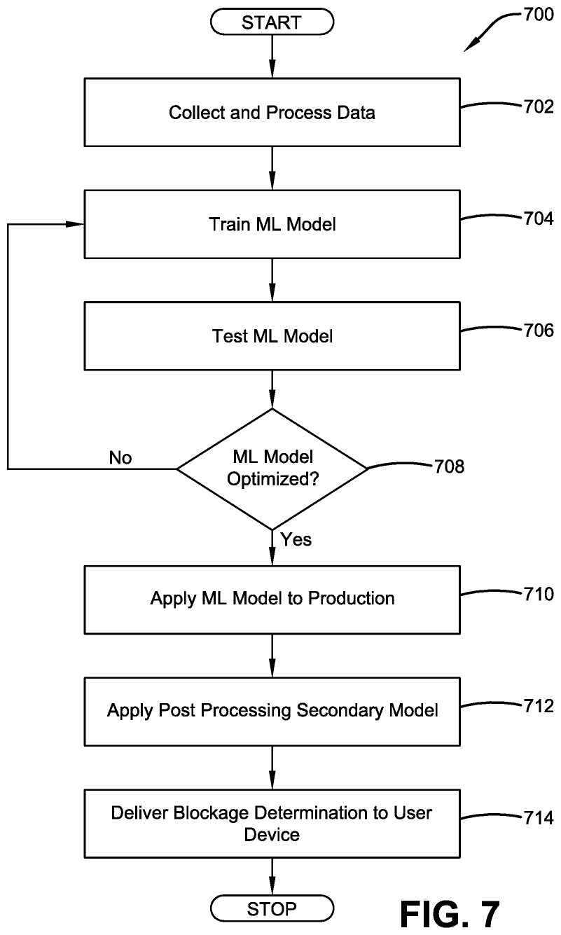

FIG. 7 is a flow diagram illustrating an exemplary method 700 of supervised learning using a ML model and other tools. For example, an ML model can comprise a set of data (e.g., in a file or database) that has been trained (e.g., using supervised learning) to recognize target patterns. As an example, a model can be trained over a set of data, which results in an algorithm that can be used to reason over and learn from those data. In some implementations, the machine learning model is an output of the training process and can be defined as the mathematical representation of the real-world process.

In this implementation, the exemplary method 700 may be used to detect blockages in a target sewer system, which may comprise collecting and processing the data (step 702), for example, as described above. The ML model can be trained to recognize blockages and types of blockages (step 704), and the ML model can be tested (step 706) to determine if the ML model is appropriately trained for production of the desired results (step 708). For example, a K-fold cross validation can be used to find the desired model that provides optimal results. In this example, the training and testing can be optimized using an iterative process at least until a desired level of production (e.g., correct prediction percentages) has been achieved. In some implementations, advanced hyperparameter optimization methods may be used, such as Bayesian (e.g., hyperopt library), genetic algorithms, or other global optimization techniques.

Further, at 710, the ML model can be applied to production (e.g., in-field or real-world use. At 712, a postprocessing/decision stage can be used to apply a post processing secondary model to the ML model. As an example, hydrology engineering formulas may be applied to the model to improve the ML process, and a final decision rule can be applied. Additionally, at 714, the blockage determination can be delivered to the user device.

As an illustrative example, data may be collected from the input device 104 and processed as illustrated in step 702. The data may correspond to various sewers with or without blockages. The data may be in the form of flow depth, flow velocity, flow rate, rainfall, temperature, etc. The data may represent blockages of a variety of types, such as root intrusion; sediment build-up; debris; fats, oils, and grease (FOG), etc. Further, the data may be collected over a period of time at pre-determined intervals. For example, the flow depth at a location may be measured at 15-minute intervals totaling 96 samples per day. It should be appreciated that the data may be collected at any suitable interval. Each sample or reading may be labeled with a corresponding property or characteristic. In an example, the data may be labeled as a blockage or a non-blockage (e.g., depending of confirmation). In another example, each day may be labeled with a corresponding property (e.g., labeled as a blockage or a non-blockage). Further, the data may be labeled as a root intrusion, sediment build-up, FOG blockage, or other similar label (e.g., based on visual confirmation).

Further, in step 702, the data may be processed to provide a dataset to the ML model that is complete, substantially free from error, substantially free from bad values, having a consistent sampling rate, etc. The data may be processed by correcting for anomalous or bad values, filling in missing values, resampling the data, correcting out of range values, and smoothing the data. The data may be processed to remove trends and account for seasonal variation (e.g., weekday versus weekend trends, other situations where outflow may vary according to use). The data processing in step 702 may be completed either manually or automatically (e.g., through use of a computer).

The prediction platform 102 may correct for anomalous or bad values or out-of-range values by replacing the values with an estimate. For example, a data value may indicate an extremely high value because of an error with the input device 104. The prediction platform 102 may estimate by interpolating a value to replace the anomalous data value.

Missing data values may be inserted into the data sample to provide for a consistent sample of values. For example, an input device 104 may have been temporarily suspended or powered off for a period of time. The prediction platform 102 may provide a data value using interpolation or any other suitable method to ensure that the dataset is free from missing values.

The data may also be resampled to provide a dataset with a consistent sample rate. A sample rate may correspond to the rate at which data is sampled from an input device 104 over a period of time. For example, a sample rate from an input device 104 comprise 5-minute intervals for a first period of time. The sample rate for the same input device 104 comprise 15-minute intervals for a second period of time. The data from the input device 104 at both sample rates may be resampled to give a new dataset having data at only 15-minute intervals. It may be desirable to have data at a consistent sample rate for input into the ML model.

In another example, smoothing may be applied to remove abnormally high or low values in the data while preserving the bulk of the data in the dataset. In this example, this may make patterns in the dataset more visible, for example. A moving average may be taken for the data values over time to provide for a smoother graph of data. Smoothing may be performed at a level that preserves the data integrity while still providing a smoothing effect (e.g., still removing outliers in the dataset).

In yet another example, the data may be prepared and placed into labeled windows representing a set period of time. For example, the raw data may be sampled every 15 minutes. The data may be in segments of any desired length of time. One dataset may be accrued across a 10-day timeframe, another may be accrued over a 3-day timeframe, etc. In step 702, data may be combined or broken up into 3-week (18-day) segments/windows. This may allow the ML model to receive windows of data that are sampled at the same rate for the same number of days. For example, a window may include 18 days of data sampled at every 15 minutes and labeled as a blockage or non-blockage. It should be appreciated that the data may be sampled and prepared at any rate and prepared into windows of any length of time according to sound engineering judgment.

In an example, various engineered features may be applied to further analyze and prepare the data. For example, flexible binning, statistics, basic hydrology, and synthetic hydrology features may be applied. Flexible binning may be used to group data in desired bins and further prepare it for ML. In an example, the data may be time binned into sub-day (e.g., morning and evening) segments for analyzing. Statistics may be used to compare various data points for added analysis. For example, flow depth may be compared with other values such as rainfall, etc. Hydrology formulas may also be applied to the data. For example, the Froude number (Fr) and Reynolds number (Re) may be calculated to indicate conditions within a sewer.

In another example, modern multi-resolution time-frequency analysis may be used to detect basic rhythms in the data for a more efficient analysis.

In another example, ML sub-models such as dynamic time warping may be applied. Dynamic time warping is an algorithm for measuring similarity between two temporal sequences that may vary in speed. For example, dynamic time warping may be used to detect similarities in flow depth data between days (e.g., may determine if data from the current day is similar to data of previous days). This may help find abnormalities in the data and may help detect issues in the sewer system. Dynamic time warping may allow a user to take one dataset and find other datasets that have similar characteristics.

It should be appreciated that other sub-models or algorithms may be applied within the main ML model as desired to obtain the desired result (e.g., model stacking, Meta Ensembling, etc.). Multiple predictive models and algorithms may be applied to provide an effective predictive model.

In step 704, the ML model may be trained to better detect blockages in sewers. The ML model may be any suitable ML model such as a classical ML model with a gradient boosted decision tree library. The ML model may also be a deep neural network with long short term memory or gated recurrent units. Various methods or techniques may be used to train the ML model. Such methods or techniques may be K-fold cross validation or Bayesian hyperparameter optimization. K-fold cross validation may be used to evaluate various ML models to evaluate the model's performance using a set of new data. The K-fold cross validation process may measure how accurately a ML model predicts the presence or type of blockage in a sewer.

In the training step 704, a training database may be used specifically for training the ML model. The database may include time series data in 18-day windows, sampled at 15-minute intervals, or other intervals, and labeled as either a blockage or a non-blockage. The ML model may learn to predict sewer blockages while using the pre-labeled data from the training database and a method of supervised learning. During the training step 704, various parameters and features of the ML model may be modified and fine-tuned to improve the ML model accuracy.

In an example, the Bayesian hyperparameter optimization method may be used to fine-tune parameters of any of the various steps described above. A hyperparameter is a parameter that may be used to control the learning process of a ML model. Bayesian optimization aims to update the ML model to increase performance and accuracy. Hyperparameters of the ML model or sub-models may be updated in this process.

In another example, the output from the ML model may be a value from zero (0) to one (1). A zero may represent a non-blockage and a one may represent a blockage. The ML model may output a decimal between zero and one. A threshold may be set for when a blockage is determined (e.g., values from 0 to 0.06 may represent a non-blockage; values from 0.06 to 1 may represent a blockage). The outputs may be remapped to a threshold of 0.5 (e.g., values from 0 to 0.5 may represent a non-blockage; values from 0.5 to 1 may represent a blockage). Further, the threshold may be calculated and fine-tuned automatically by the ML model as model training is a continuous process.

In step 706, the accuracy of the ML model may be tested. A testing database may be used and may have a different set of data than the training database. The testing database may include data that has been collected and prepared according to any of the previous steps; however, the data may not include labeled blockages. In this way, the ML model may make its own blockage predictions, which may then be compared to known blockage information. Accuracy may be determined by how well the ML model predicts sewer blockages. K-fold cross validation may also be used in step 706 to evaluate various ML models to evaluate the model's performance using the testing database. The K-fold cross validation process may measure how accurately a ML model predicts the presence or type of blockage in a sewer.

In step 708, it may be decided whether or not the ML model is optimized for a production system. The determination may be based at least in part on the accuracy of the ML model as determined in the testing step 706. If the ML model is sufficiently optimized, it may be applied in a production setting. If the ML model is not sufficiently optimized, it may be trained and tested further in steps 704 and 706. It should be appreciated that training and testing of the ML model may be an ongoing process and that a ML model that has been applied in a production setting may always be re-trained and re-tested as necessary using sound engineering judgment.

In step 710, the trained and tested ML model may be applied to a production system. The production system may include an input device 104, a user device 106, a production database 210, and a blockage prediction platform 102. Data included in the production database may be collected from the input device 104 and processed using any of the methods described above (e.g., in step 702). The data may be in 18-day windows at 15-minute (e.g., or other) intervals; however, the data may not be labeled as a blockage or a non-blockage.

In an example, the output from the production ML model may be a value from zero (0) to one (1). A zero may represent a non-blockage and a one may represent a blockage. The ML model may output a decimal between zero and one. A threshold may be set for when a blockage is determined (e.g., values from 0 to 0.1 may represent a non-blockage; values from 0.1 to 1 may represent a blockage). The outputs may be remapped to a threshold of 0.5 (e.g., values from 0 to 0.5 may represent a non-blockage; values from 0.5 to 1 may represent a blockage). Further, the threshold may be calculated and fine-tuned automatically by the ML model as model training is a continuous process.

In step 712, post processing methods may be applied to the raw output data from the ML model of step 710. The raw output data may be a number from zero to one identified as either a blockage or a non-blockage. Step 712 may further analyze the raw output data by applying additional secondary models, algorithms, hydrology formulas, rules, or the like to further analyze, verify, or fine tune the predictions of the ML model from step 710.

Other rules (e.g., post-processing rules) may be applied in step 712 to ensure accurate blockage predictions. For example, a rule may state that if a blockage prediction estimate is above a specified threshold for two days in a row, the model will indicate a blockage. It should be appreciated that in this example, the threshold value and number of days may be changed for each application as necessary.

In another example, specific rules may be applied based on a specific customer or location. For example, regional information may be applied when determining the final blockage prediction. Rainfall for a specific location, temperature, geography, various weather patterns, historical reports, etc. may be used as well.

In step 714, the determinations of the ML model may be displayed on a user device 106. The determination may be information such as the presence of a blockage or the type of blockage in a sewer system. The determination may be based on the predictions of the ML model in steps 710 and also from the post processing analysis from step 712. Using both ML predictions and post processing methods may ensure more accurate blockage predictions.

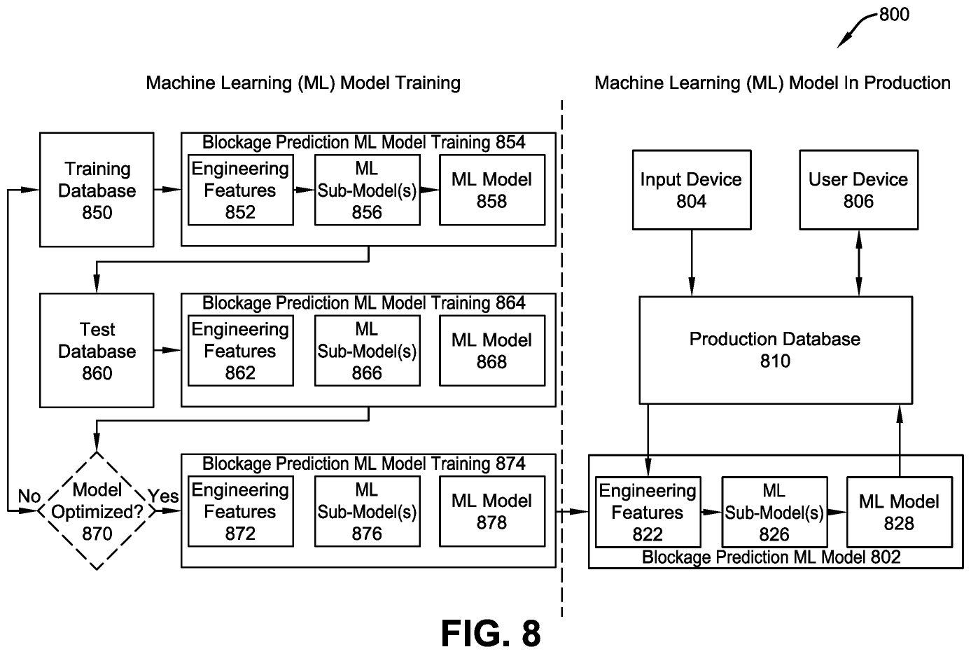

Turning to FIG. 8, an exemplary ML model in a training environment and a ML model in a production environment are shown at 800. A blockage prediction ML model in training 854 may use a training database 850 to train the model in training 854. The ML model in training 854 may include engineered features 852, ML sub-model(s) 856, and a ML model 858. The various features in the ML model in training 854 may operate in a similar manner as the various features described herein (e.g., similar to features as described in FIG. 2, etc.). The ML model in training 854 may be trained according to any of the methods described herein (e.g., similar to training methods described in FIG. 7, etc.).

After the ML model has been trained, the ML model may be tested. The ML model in evaluation 864 may use a testing database 860 to train the model in evaluation 864. The ML model in evaluation 864 may include engineered features 862, ML sub-model(s) 866, and a ML model 868. The various features in the ML model in evaluation 864 may operate in a similar manner as the various features described herein (e.g., similar to features as described in FIG. 2, etc.). The ML model in evaluation 864 may be evaluated and tested according to any of the methods described herein (e.g., similar to testing methods described in FIG. 7, etc.).

Shown as 870, it may be decided whether or not ML model 864 is sufficiently optimized for a production environment. If the ML model 864 is not sufficiently optimized, the model may be trained further using the training database 850. If the ML model 864 is sufficiently optimized, the ML model 864 may be applied to a production environment, as shown in FIG. 8.

The blockage prediction ML model 802 may be used to predict blockages in a production environment. The production environment may include an input device 804, a user device 806, a production database 810, and a blockage prediction ML model 802. The blockage prediction ML model 802 may include engineered features 822, ML sub-model(s) 826, and a ML model 828. The production environment may include similar devices and may operate in a similar manner as various examples described in this application. For example, the production environment may operate in a similar manner as the environment depicted in FIG. 2. It should be appreciated that the blockage predict ML model 802 may be modified, updated, may evolve, be re-trained, and re-tested as required by sound engineering judgment.

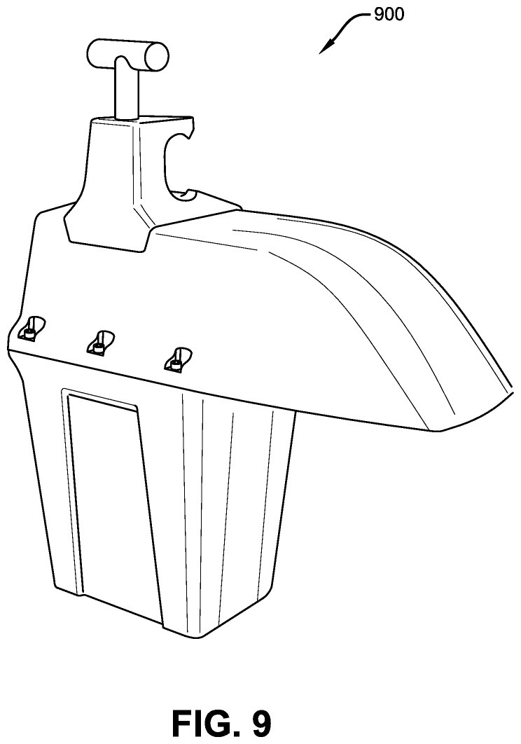

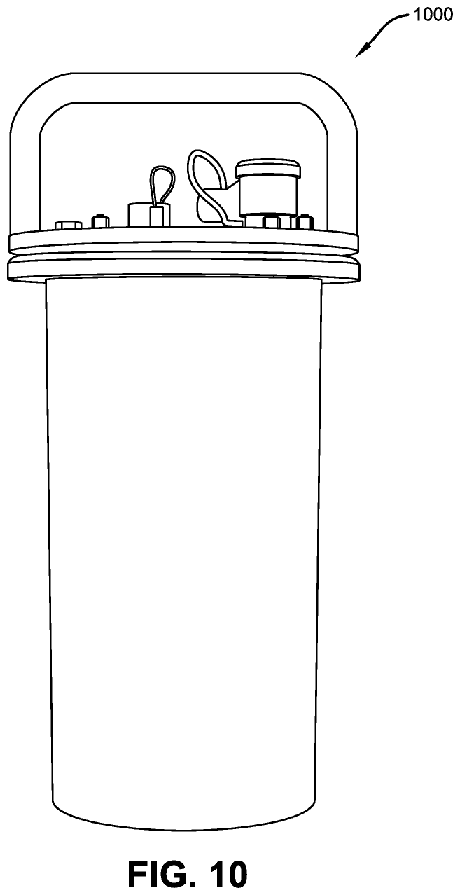

Turning to FIGS. 9 and 10, exemplary input devices 900, 1000 are shown. Device 900 is an exemplary level monitor that may be used with the system 100. Device 1000 is an exemplary flow monitor that may be used with the system. These devices 900, 1000 are shown as examples and are not meant to limit the scope of devices that may be used as an input device. Input devices may provide flow depth, flow velocity, flow rate, temperature, rainfall, pressure, or any other value as deemed appropriate.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A system for detecting an obstruction of flow, comprising:
one or more input devices respectively comprising a sensor that generates real-time data indicative of a detected a fluid flow characteristic in a target sewer system;
a blockage prediction platform comprising a machine learning model, the blockage prediction platform operably receiving the real-time data from the one or more input devices and determining a blockage prediction for the target sewer system based on the real-time data; and
a user device communicatively coupled with the blockage prediction platform, the user device displaying the results of the blockage prediction for the target sewer system from the blockage prediction platform;
wherein the machine learning model is trained using data indicative of a variety of blockage events.

2. The system of claim 1, the one or more input devices comprising one or more of:
a fluid level monitor; and
a fluid flow monitor.

3. The system of claim 1, the machine learning model of the blockage prediction platform trained using a supervised learning process, the supervised learning process comprising one or more of:
human labeled blockage data;
flexible binning of data;
basic and synthetic hydrology features;
multi-resolution time-frequency analysis;
another machine learning model;
K-fold cross validation; and
a hyperparameter optimization technique.

4. The system of claim 1, comprising a remote database storing data indicative of a variety of fluid characteristics for sewer systems, and data indicative of a variety of temporal conditions related to fluid flow characteristics for sewer systems, the database communicatively coupled with the blockage prediction platform.

5. The system of claim 4, the database comprising data binned into one or more data sets based on predictive learning determinations from the blockage prediction platform.

6. The system of claim 4, the database comprising data used by the prediction platform to determine whether a blockage event is present in one or more portions of the target sewer system.

7. The system of claim 1, the user device comprising one or more of:
a mobile computing device;
a computing station; and
a remotely accessed we-based application.

8. A method for determining the existence of an obstruction of flow, comprising:
collecting at a plurality of data related to fluid flow in a variety of sewer systems;
processing the data to correct for anomalies;
preparing the data into labeled windows indicative of a set period of time;
applying engineered features to the data;
applying a machine learning model to the data;
training the machine learning model; and
applying the trained machine learning model to a target sewer system to determine the existence of an obstruction of flow.

9. The method of claim 8, comprising receiving real-time fluid flow data from one or more input devices disposed in the target sewer system, the real-time data indicative of real-time fluid flow characteristics.

10. The method of claim 9, comprising using a blockage prediction platform, comprising the trained machine learning model, to determine a blockage prediction for the target sewer system based on the real-time data from the one or more input devices.

11. The method of claim 10, comprising using a user device display the results of the blockage prediction for the target sewer system from the blockage prediction platform.

12. The method of claim 8, the processing of the data to correct for anomalies comprising one or more of:
correcting for bad values;
filling in missing values;
resampling to correct values;
correcting out-of-range values; and
smoothing a range of values.

13. The method of claim 8, the applying of engineered features to the data comprising one or more of:
using flexible binning of data into bins based on time windows;
applying basic and/or synthetic hydrology features; and
applying machine learning sub-models including dynamic time warping.

14. The method of claim 8, the applying a machine learning model to the data comprising applying a gradient boosted decision tree library;

15. The method of claim 8, the training of the machine learning model comprising performing K-fold cross-validation to find the optimized model.

16. The method of claim 8, comprising applying a postprocessing secondary model to the machine learning model, comprising applying hydrology engineering formulas to the model.

17. A method for detecting an obstruction of flow in a target sewer system, comprising:
collecting of data indicative of one or more fluid flow characteristics in a sewer system related to a blockage event;
processing the data to correct for anomalies, filling in missing values, and applying smoothing;
applying at least one engineered feature to the data;
applying at least one of a machine learning model to the data;
evaluating the at least one machine learning model;
optimizing the at least one machine learning model to arrive at an optimized machine learning model; and
applying the trained machine learning model to a target sewer system to determine the existence of an obstruction of flow.

18. The method of claim 17, comprising receiving real-time fluid flow data from one or more input devices disposed in the target sewer system, the real-time data indicative of real-time fluid flow characteristics.

19. The method of claim 18, comprising using a blockage prediction platform, comprising the trained machine learning model, to determine a blockage prediction for the target sewer system based on the real-time data from the one or more input devices.

20. The method of claim 19, comprising using a user device display the results of the blockage prediction for the target sewer system from the blockage prediction platform.
